(19) United States
(12) Patent Application Publication
(10) Pub. No.: US 2015/0090117 A1
(43) Pub. Date: Apr. 2, 2015

(54) GAS TREATMENT SYSTEM USING SUPERSONIC SEPARATORS

(71) Applicant: FMC Kongsberg Subsea AS, Kongsberg (NO)

(72) Inventors: Erik Baggerud, Jar (NO); Robert Perry, Katy, TX (US); Jostein Kolbu, Fornebu (NO)

(21) Appl. No.: 14/380,694

(22) PCT Filed: Feb. 21, 2013
(86) PCT No.: PCT/EP2013/053420

§ 371 Date: Aug. 22, 2014

(30) Foreign Application Priority Data
Feb. 23, 2012 (NO) 20120194

(51) Int. Cl. B01D 53/26

(52) U.S. Cl. CPC B01D 53/26
USPC 95/30; 96/175; 96/4

(57) ABSTRACT

A crude natural gas stream treatment system comprising a first supersonic separator and a second supersonic separator, wherein the first supersonic separator comprises a crude gas inlet, a dry gas outlet and a first liquid outlet; wherein the second supersonic separator comprises a dry gas inlet, a treated gas outlet and a second liquid gas outlet, and wherein the dry gas outlet is in fluid communication with the dry gas inlet is disclosed.

The present invention relates to a gas treatment system for conditioning of a crude natural gas stream. Especially the present invention relates to a compact system for dew pointing and sweetening of crude natural gas. The system is applicable both for topside and subsea gas treatment.

### BACKGROUND

The invention comprises a gas treatment system for removal of CO₂ to meet the specification on CO₂ content in downstream export pipelines to avoid corrosion, additionally the system provides for the removal of water. For fields with large volumetric content of CO₂ the removal with re-injection of the CO₂ reduces the volumetric flow rate of export gas, hence potentially reducing the dimensions of export pipelines. The re-inject of CO₂ can further be an EOR (Enhanced Oil Recovery) measure. All these aspects have economical benefits that can be realized in an overall field development. The system may be implemented topside or subsea.

In pipeline system for export of gas from a gas field there are usually specific requirements to the maximum allowed CO₂ content in the gas stream. The main reason is that in a system where free liquid water is present CO₂ is a sour component and increases the corrosion rate of the pipeline materials. Further there may be restrictions to the content of CO₂ allowed in the gas at the receiving facilities due to limited processing capacity for CO₂ removal prior to export to the market.

For reservoirs where there is significant amounts of CO₂ there are basically two solutions, either make the export pipelines in stainless steel alloy or remove the CO₂ prior to export. The former solution is generally very expensive and will easily make the field development too expensive, of course dependent on the length of the pipeline. Existing CO₂ removal technologies generally comprise physically large process systems typically membranes or absorption processes (e.g. amine solvent absorption). These processes have considerable complexity and utility requirements (power, heat and/or chemicals). Reducing the size and complexity of the CO₂ removal system can potentially be of great interest to the industry.

The removal of water is necessary to avoid the formation of ice and hydrates, which can damage equipment like separators, valves, pumps and instrumentation.

### PRIOR ART

Conventional solutions for dehydration of crude natural gas and for removal of acid carbon dioxide comprise the use of a combination of different absorption processes. One known process for dehydration of crude gas is absorption of water vapour in glycol such as TEG (triethylene glycol) to obtain dry natural gas. The glycol is heated to remove the absorbed water and thereafter reused for absorption. Carbon dioxide can be removed by absorption in an amine solution; different types of amines are presently being used for this type of processing. Bringing the gas in sufficient contact with the absorbent solution requires considerable effort and has previous been performed using contactor columns of considerable heights. The absorbent is regenerated in a stripper column requiring heating. Alternative prior art solutions for carbon dioxide removal from natural gas involve the use of selective membranes where carbon dioxide is forced to pass a membrane by a concentration and/or pressure gradient.

WO2006/089948 discloses a method and system for cooling a natural gas stream and separating the cooled stream into various fractions, such as methane, ethane, butane and propane, utilizing a supersonic or transonic cyclonic expansion and separation device.

WO 00/40834 elates to a method for removing condensables from a natural gas stream, at a wellhead, downstream of the wellhead choke thereof. The natural gas stream is induced to flow at supersonic velocity through a conduit of a supersonic inertia separator and thereby causing the fluid to cool to a temperature that is below a temperature/pressure at which the condensables will begin to condense.

### OBJECTIVES OF THE INVENTION

The present invention aims at providing a compact gas treatment system. The treatment system should limit the pressure loss and need for re-pressurisation. Further in a preferred embodiment the system should be applicable for subsea operation providing the possibility to keep the natural gas or at least the main part there of subsea during the whole treatment process. The system and process should result in a gas stream of pipeline export quality with limited demands to the pipeline material, and with limited tendency to form gas hydrates.

An objective of the invention is to provide a topside gas treatment system replacing physically large units of conventional technologies. It is also a goal to provide a system and a method that would facilitate for moving processing today performed at a platform to the seabed and make topside facilities obsolete. Accordingly it is an intension that the system and method are able to process gas to meet the specification of the export pipeline as well as removing CO₂ in the fluid subsea, which will reduce the need for treatment systems at the receiving facilities, pending on the end-use of the gas.

These and other objectives are achieved through [the use of] the system and method according to the present invention.

The present invention provides a crude natural gas stream treatment system comprising a first supersonic separator and a second supersonic separator, wherein the first supersonic separator comprises a crude gas inlet, a dry gas outlet and a first liquid outlet; wherein the second supersonic separator comprises a dry gas inlet, a treated gas outlet and a second liquid outlet, and wherein the dry gas outlet is in fluid communication with the dry gas inlet.

In one aspect of the invention the system further comprises a first additional separation system with at least a treated gas inlet, a sweet gas outlet, a CO₂ gas outlet, wherein the treated gas outlet is in fluid communication with the treated gas inlet.

The first additional separation system is in one embodiment an absorption solution cycle system and in another embodiment the first additional separation system is a membrane separation system.

In another aspect of the present invention the system further comprises a first heat exchanger with a cooling medium inlet in fluid communication with the treated gas outlet and a cooling medium outlet in fluid communication with the treated gas inlet, and an inlet for a medium to be cooled in fluid communication with the dry gas outlet and a cooled fluid outlet in fluid communication with the dry gas inlet.

In yet another aspect the system further comprises a second additional treatment system with at least a fluid inlet, a CO₂ outlet and a hydrocarbon outlet, wherein the second liquid outlet is in fluid communication with the fluid inlet, and the hydrocarbon outlet is in fluid communication with the treated gas outlet or the sweet gas outlet.

In one embodiment the second additional separation system is an absorption solution cycle system in another embodiment the second additional separation system is a membrane separation system, in yet another embodiment the second additional separation system is flash separation system. In another embodiment the second separator system may be a membrane separation system, with the membrane system adapted to separate out the wanted element. Further the second additional separation system may also be a third supersonic separator.

In an aspect of the present invention the system further comprises a first heat exchanger with a cooling medium inlet in fluid communication with the second liquid outlet and a cooling medium outlet in fluid communication with the fluid inlet, and an inlet for a medium to be cooled in fluid communication with the dry gas outlet and a cooled fluid outlet in fluid communication with the dry gas inlet.

In another aspect the first liquid outlet is in fluid communication with a well stream upstream an initial phase separator, where the initial phase separator comprises a crude gas outlet in fluid communication with the crude gas inlet.

In one aspect of the present invention the system is applicable for subsea installation.

Further the present invention provides a crude natural gas treatment method, comprising passing crude natural gas through a first supersonic separator and a second supersonic separator, wherein the first supersonic separator the crude natural gas is cooled and a first condensed liquid stream is separated of providing a dry gas stream, and wherein the second supersonic separator the dry gas is cooled and a second condensed liquid stream is separated of, thereby providing a treated gas stream.

In one aspect of the method the second liquid stream comprises mainly CO₂, and C2 to C4 hydrocarbons.

In another aspect the method further comprises feeding the treated gas to a first additional treatment system.

In yet another aspect the first additional treatment system comprises bringing the treated gas in contact with a CO₂ absorption solution, absorbing CO₂ in the solution, thereby obtaining a sweetened gas stream, and regaining the solution by desorption of the absorbed CO₂ or the first additional treatment system comprises bringing the treated gas in contact with a CO₂ selective membrane, letting CO₂ pass trough the membrane to obtain a sweetened gas stream.

In another aspect the method further comprises heating the treated gas upstream the first additional treatment system by heat exchange with the dry gas.

An aspect of the invention is feeding the second liquid to a second additional treatment system. Optionally the method comprises heating the second liquid through heat exchange with the dry gas upstream the second supersonic separator, thereby obtaining a second fluid.

The second additional treatment system may comprise bringing the second fluid in contact with a CO₂ absorption solution, absorbing CO₂ in the solution, thereby obtaining a hydrocarbon gas stream, and regaining the absorption solution by desorption of the absorbed CO₂, or it may comprise bringing the second fluids in contact with a CO₂ selective membrane, letting CO₂ pass trough the membrane to obtain a hydrocarbon gas stream. Alternatively the second additional treatment system comprises flashing of hydrocarbons from the second liquid to obtain liquid CO₂ or the second additional treatment system comprises passing second fluid trough a third supersonic separator, condensing and separating of liquid CO₂ and obtaining hydrocarbon gas.

One aspect of the present invention comprises feeding the first liquid to a well stream upstream a phase separator, where the crude natural gas stream is obtained from said phase separator.

It is an aspect of the present invention that the method is performed subsea.

### BRIEF DESCRIPTION OF THE DRAWINGS

The present invention will be described in further detail with reference to the enclosed drawings. The drawings are schematic diagrams illustrating the main principles of the invention.

FIG. 1 shows the overall system from the subsea well to the gas receiving facilities.

FIG. 2 illustrates the main principles of a first embodiment of the present invention.

FIG. 3 illustrates in further details the first embodiment of the present invention.

FIG. 4 illustrates a second embodiment of the present invention.

FIG. 5 illustrates a third embodiment of the present invention.

FIG. 6 illustrates a first possible embodiment of an additional treatment system.

FIG. 7 illustrates a second possible embodiment of an additional treatment system.

FIG. 8 illustrates a third embodiment of an additional treatment system.

### PRINCIPAL DESCRIPTION OF THE INVENTION

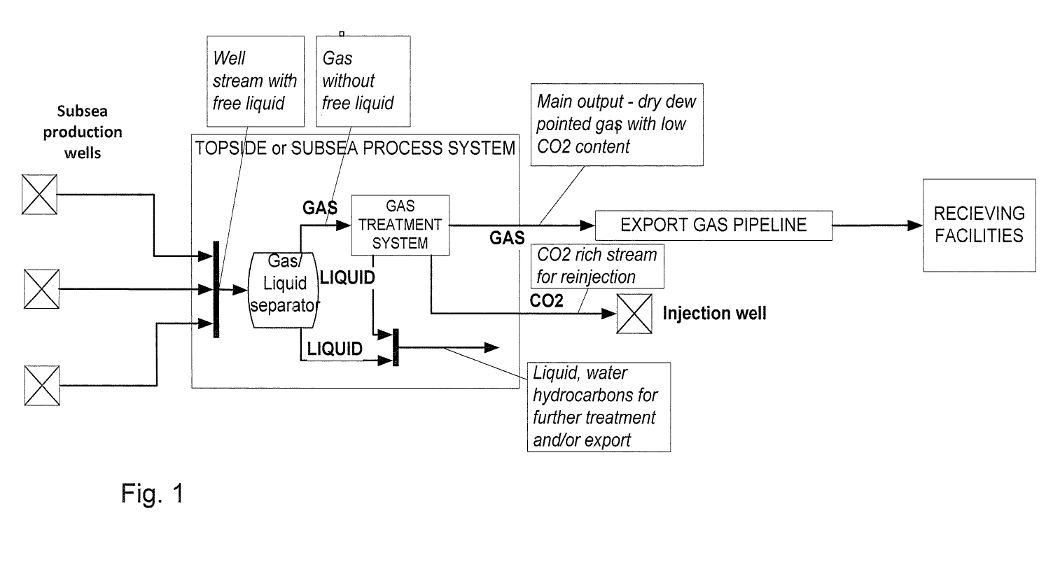

The present invention relates to a gas treatment system. The term “gas treatment system” as applied here is used to refer to a system for processing the gas stream separated from a well stream to obtain a gas stream that can be exported. This function of the gas treatment system is illustrated in FIG. 1. Here three subsea wells deliver a well stream comprising free liquid, the free liquid comprises water and condensate, to a gas/liquid separator. The well stream is a water saturated hydrocarbon stream and before entering the gas treatment system according to the invention this well stream is processed in a phase separator. The separator may be a two phase or three phase separator, and the configuration thereof can be freely selected as long as the separator provides a generally liquid free gas stream. The generally liquid free gas stream is hereinafter referred to as crude natural gas stream. It is this generally liquid free gas stream that the gas treatment system according to the present invention is prepared to process. Gas streams from potential downstream liquid treatment steps may be boosted and combined with the primary liquid free gas stream. The treatment system produces a dew pointed gas stream with a lowered CO₂ content that can be transported through an export gas pipeline to receiving facilities. CO₂ rich stream separated from the gas stream can be transported to an injection well for re-injection possible to keep up the reservoir pressure. Liquid streams from the gas/liquid separator and the gas treatment system can be processed through other system not forming a part of the present invention.

One embodiment of the present invention can remove the need for large and complex processes and replace it by more compact supersonic separation technology. This can reduce the overall footprint, operational complexity and utility cost for the CO₂ removal system.

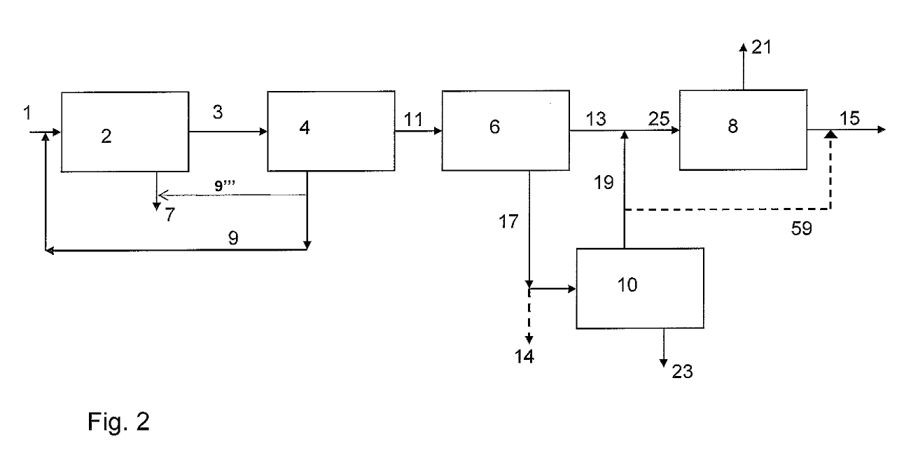

FIG. 2 illustrates a first embodiment of the present invention. A well stream 1 comprising gas and liquid enters a phase separator 2 to obtain a gas stream 3 and a liquid stream 7. This gas stream 3 is fed to a first super sonic separator unit 4 resulting in cooling and separation of water and heavy hydrocarbons as liquid stream 9 which is returned to the well stream or as stream 9′″ combined with stream 7 for potential further treatment. The term “heavy hydrocarbons” refers to hydrocarbons with a dew point which is higher or in the proximity of the water dew point. The gas stream 11 leaving the first super sonic separator unit 4 will be dry, the dry gas stream, that is to say it will contain limited amounts of water or other compounds which during transport or storage of the gas at low temperature would result in the formation of a liquid phase. The dry gas stream 11 is fed into a second supersonic separator unit 6 designed to cool and separated CO₂ from the dry gas stream. The liquid stream 17 leaving the separator will comprise liquefied CO₂ together with some liquefied hydrocarbons, mainly C2, C3 and C4. Depending on the composition of the well stream and the separation efficiency the obtained sweetened gas stream 13 may be according to the needed specification and can proceed to the export pipeline without further treatment. However if the sweetened gas stream 13 requires further processing to fulfil the specification for the gas export stream then the stream according to the present invention is fed to an optional first additional gas treatment system 8. In the optional first additional gas treatment system 8 additional CO₂ is removed from the gas. The CO₂ leaves the system 8 as stream 21. The fully sweetened gas 15 leaving the system 8 fulfils the specification and can be compressed and transported to a remote location. The liquid stream 17 from the second supersonic separator may contain hydrocarbons of interest. In one embodiment of the present invention this stream is optionally processed further in a second additional treatment system 10 where the hydrocarbons are separated as stream 19 and returned to the sweetened gas stream 13 from the second supersonic separator 6 and if needed passed fed to the optional first additional treatment unit 8. Alternatively if the stream 19 fulfils the specifications the stream is by passed the optional first additional treatment system and added as stream 59 directly to the fully sweetened gas stream 15. The stream 23 leaving the second additional treatment system comprises mainly CO₂ and can be pressurised and re-injected through a re-injection well. FIG. 2 also illustrates an alternative embodiment, if stream 17 contains a combination of hydrocarbons (C2 and upward) and CO₂. The alternative consists of doing no further processing and boost the stream 14 to a topside unit as fuel gas for power generation.

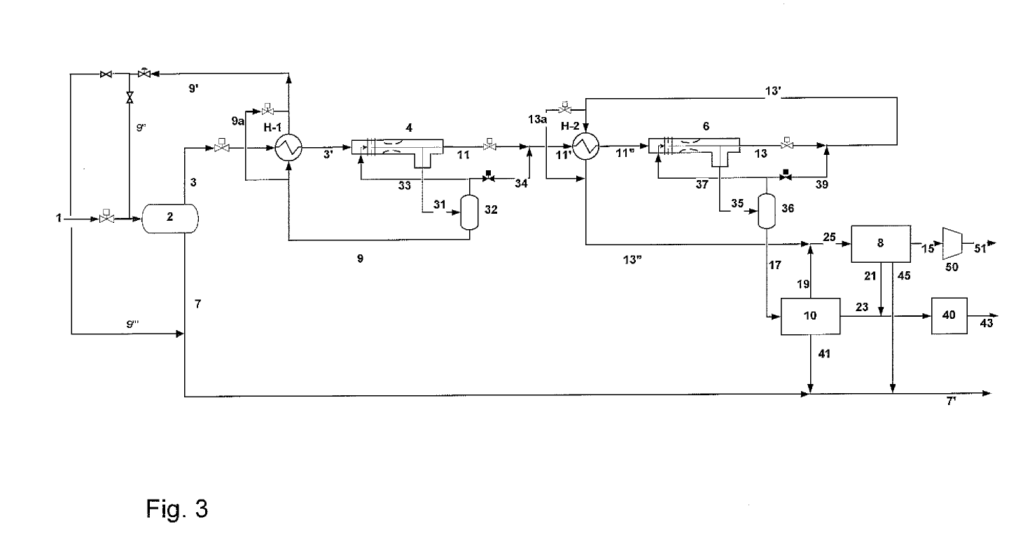

FIG. 3 is a more detailed illustration of the first embodiment of the present invention. Equal reference numbers are used for units equal to units discussed in connection with FIG. 2. Dependent on the conditions in the phase separator the pressure of the crude gas may require pressure control to get the proper inlet pressure to the gas treatment system. Pressure control is either increasing the pressure by compressor or reducing the pressure typically through a valve. In this embodiment a heat exchanger H-1 is included immediately upstream the first supersonic separator 4. The crude gas stream 3 is cooled by heat exchange with the separated liquid 9 being returned trough 9′ upstream the phase separator 2 or through 9′″ combined with the liquid outlet 7 from the phase separator. The pipeline 9a is a heat exchanger by-pass for increased control of the temperature within this part of the system.

The condition (temperature, pressure) of the feed gas 3′ to the first supersonic separator should be controlled to prevent super cooling and subsequent hydrate formation.

The first supersonic separator 4 is fed with cooled gas 3′. The separator 4 uses supersonic separation technology to reduce pressure and cool the gas such that water and higher hydrocarbons are condensed and separated as liquid. The pressure is partly regained in the discharge section of the unit. The separated liquid phase 31 is initially transported to a secondary separation tank 32 to remove any gas carried under. The separated gas is depending on the quality thereof return as stream 33 upstream the separator 4 or as stream 34 downstream the separator 4. Further the conditioned or dried gas 11′ is cooled in the heat exchanger H-2 before entering the second supersonic separator 6 as stream 11″. The sweetened gas 13′ is providing the cooling and the pipeline 13a is a by-pass for temperature control.

Conditioning of the gas upstream the second supersonic separation unit may involve pressure control and temperature control H-2. The cooling is expected to be performed by heat exchanging the cold discharge gas 13′, with the inlet stream 11′ after dehydration in the first supersonic separator 4, all dependent on the conditions of the inlet gas 1 to the system. The dehydration step upstream the CO₂ removal unit is generally required to avoid hydrate formation inside the unit.

The cooled gas 11″ is treated utilizing supersonic separation technology to reduce pressure and cool the gas such that CO₂ is condensed and separated as liquid from the gas. The pressure is partly regained in the discharge section of the unit. The initially obtained liquid stream 35 enters a secondary separation unit 36 wherein any carry under gas is separated of and returned either as stream 37 upstream the separator 6 or as stream 39 downstream the separator 6 generating the sweetened gas stream 13′ a combination of the main sweetened gas stream 13 and the return stream 39.

The liquid reject stream 17 from the gas treatment system 6 may be processed further in an optional additional processing step 10 to recover hydrocarbons condensed with the CO₂. These hydrocarbons are mainly C2 (ethane) and upwards. Methane generally goes with the main gas stream 13.

Benefits of utilizing supersonic technology compared with other technologies are generally the compactness of the units, no moving parts, no or limited utilities, simple control and limited energy requirement. The technology may also give higher discharge pressure for stream 15 and/or 23 than conventional CO₂ removal technology. Thereby the power consumption in boosting steps 50 and/or 40 can be reduced.

The CO₂ rich streams 21 and 23 from the first and second optional additional treatment systems 8 and 10 should be re-injected in the reservoir or in a disposal well. This requires boosting by unit 40 by pumping or compression dependent on the state of the fluid, i.e. liquid or gas. The boosting unit 40 provides a pressurized CO₂ rich stream.

Any separated liquid 41 and 45 from the additional systems 10 and 8 can be introduced to the main liquid stream 7 or further downstream 7′ in potential processing units if treatment of the liquid stream is performed. The handling of the liquid stream 7′ can be performed through well known methods. The main fully sweetened and conditioned gas stream 15 may be compressed by compressor 50 before leaving the gas treatment system as stream 51.

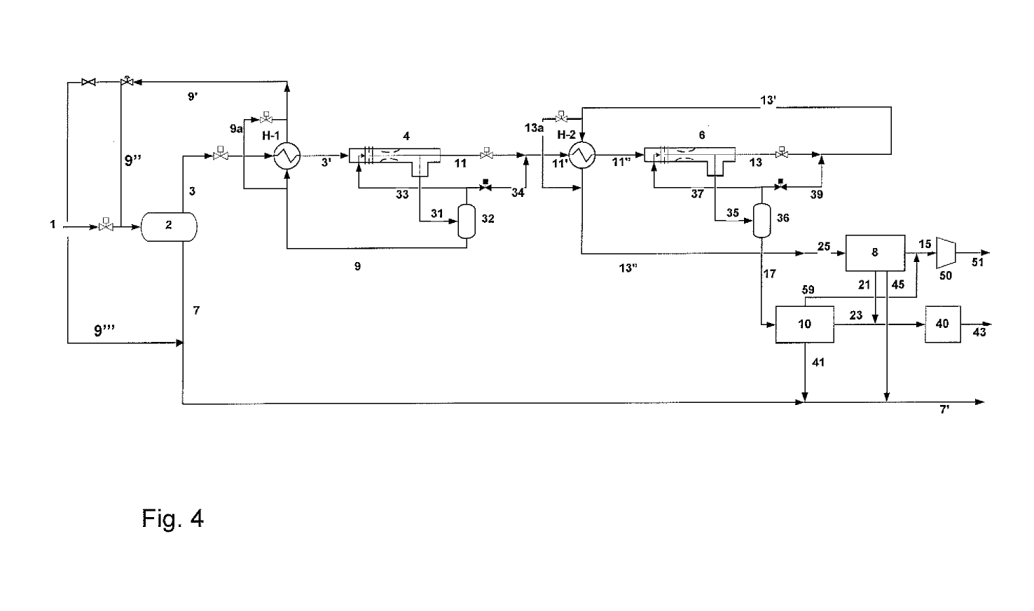

FIG. 4 illustrates an embodiment comprising the same units as the system disclosed on FIG. 3 but where the quality of the hydrocarbon gas from the second additional treatment system 10 is according to the required specification and therefore this gas is returned through pipeline 59 downstream the first additional treatment system 8.

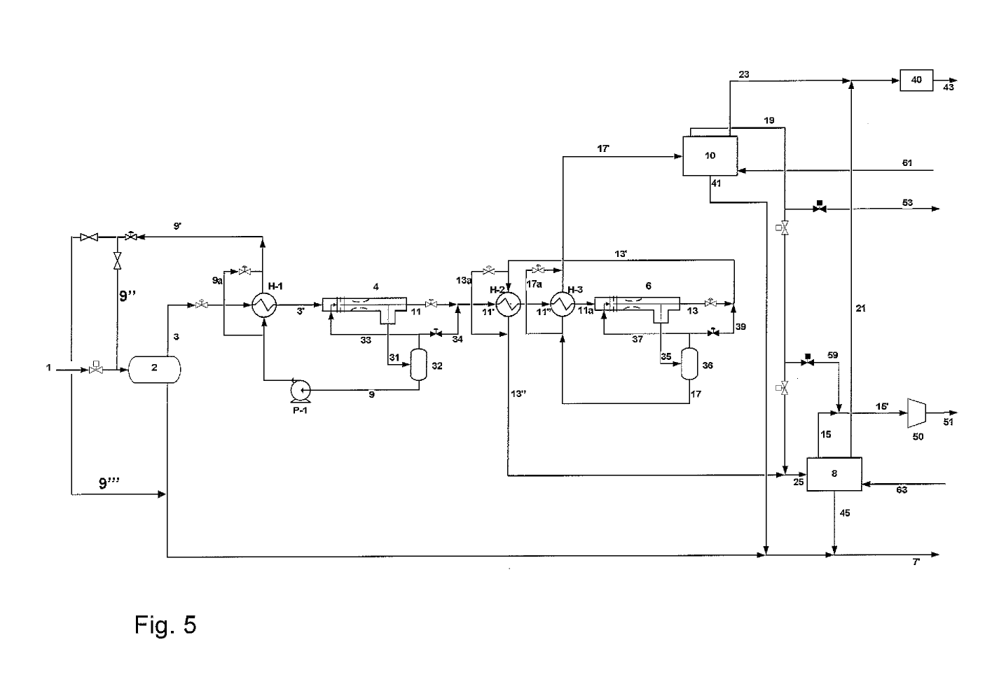

FIG. 5 illustrated another embodiment of the present invention. Equal units are given the same reference numbers. The first conditioning part of the system is unchanged when comparing with FIG. 3. Beside that a pump P-1 is installed to pump the liquid 9 downstream the phase separator. After the conditioning, downstream the heat exchanger H-2 a third heat exchanger H-3 is installed to further cool the main gas stream 11″ before it enters the second supersonic separator 6 as stream 11a. The liquid stream 17 is utilised to provide cooling before the stream enters the second additional treatment system 10 as stream 17′. The pipeline 17a is provided for controlling and provides the possibility to by-pass the heat exchanger H-3. Further illustrated on FIG. 5 is the possibility to utilize the hydrocarbon stream 19 from the second additional treatment system as fuel for power generation for this are other systems. For this purpose the pipeline 53 is provide for removing the hydrocarbons from the gas treatment system.

Additionally FIG. 5 illustrates that the first and the second additional treatment systems 8 and 10 might rely on the supply of supplement treatment solution. These would be supplied through pipes 63 and 61, respectively.

Further the present invention provides hybrid solutions combining supersonic separation technology with membrane technology can reduce the required membrane area, reduce utility requirements and also handle challenges with respect to selectivity of CO₂ versus methane. The selectivity of CO₂ versus methane can be improved by embodiments of the current invention.

Also provided by the present invention are hybrid solutions combining supersonic separation technology with absorption cycle process units. The combination can reduce the size of the absorption system, reduce utilities need, absorption fluid content and make-up stream.

The optional first and second additional treatment systems 8 and 10 illustrated in the figures can accordingly be based either on membrane technology or on the utilization of an absorption solution or a combination thereof.

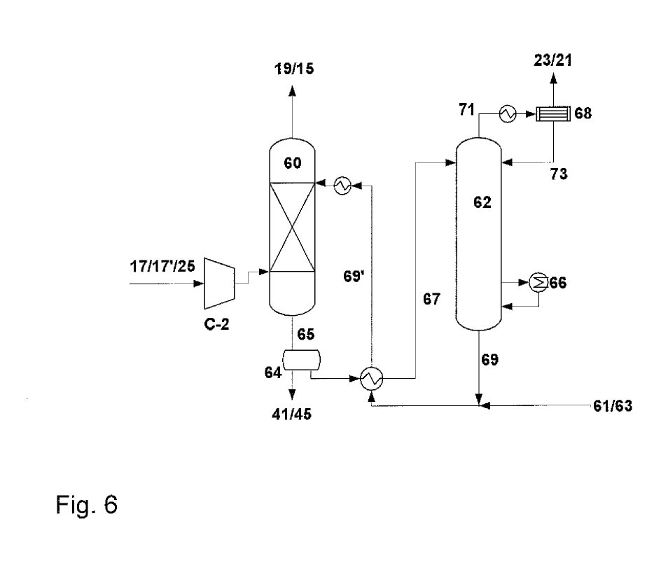

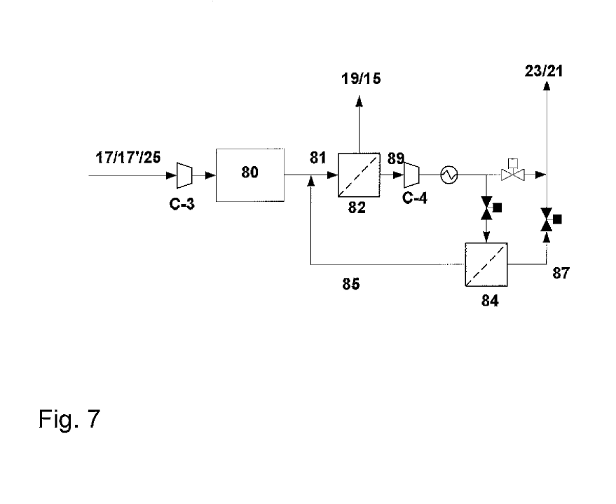

The systems 8 and 10 can be selected from the systems illustrated on FIGS. 6 and 7 respectively. FIG. 6 illustrates an absorption system based on a liquid CO₂ absorbent solution. The use of different amine based absorbents as well as other absorbents is well known in the art. The configuration of such a system is also well known and the present invention can generally apply any equivalent liquid absorption system. The stream 17/17′/25 comprising CO₂ and hydrocarbons is obtained from the second supersonic separator 6. If the unit illustrated in FIG. 6 is the first additional treatment system 8 then the gas stream to be treated is stream 25 as indicated in FIGS. 2 to 5. If the unit illustrated in FIG. 6 is the second additional treatment system 10 then the gas stream to be treated is stream 17 as indicated in FIGS. 2 to 4 or stream 17′ as indicated in FIG. 5. Similarly the output streams from the treatment system refer to streams indicated in the previous figures. In the system in FIG. 6 the stream to be treated is optionally firstly compressed in the compressor C-2. The need for the compressor depends on the pressure loss through the earlier stages of the treatment. If the liquid stream 17 from the second supersonic separator is fed to the system the fluid should preferably be converted to gas phase generally by heating before or when entering the treatment system. The gas stream to be treated enters a contactor 60 where it is brought in contact with a lean absorption solution 69′. CO₂ is absorbed in the solution which leaves the system as rich solution 65. Any liquid hydrocarbons are separated of from the stream 65 in the separator 64 and leave the system as stream 41/45 to be processed together with the other hydrocarbon containing liquid streams. The rich absorption solution proceeds as stream 67 to desorption column where it is heated to released the CO₂ and regain lean absorption solution 69. CO₂ depleted gas leaves through the top of the contactor 60 as stream 19/15/59. The gas stream is processed further as discussed in connection with the previous figures. The stream 71 leaving over the top from the desorber comprises CO₂, and any absorption solution that is carried over is condensed in the condenser 68 and returned as stream 73. The obtained CO₂ stream 23/21 leaves the system to be processed further as discussed above in relation to the other figures. A heater 66 or similar arrangements provides the heat for the desorption process. If needed fresh absorption solution is supplied to the lean solution 69 by the stream 61/63 comprising make-up solvent.

Benefits gained from a hybrid solution where the supersonic unit 6 removes the bulk of CO₂ and the first additional treatment system 8 is an absorption cycle according to FIG. 6 compared with a pure absorption cycle process system as described in FIG. 6 are:
Reduced volume of solvent required
Reduced size of contactor and regeneration columns
Reduced size of additional equipment such as pumps, heat exchangers, coolers etc.
Reduced duty of reboiler in desorption/regeneration column
Reduced volume flow of solvent make-up stream

These benefits should reduce the overall size and utility requirement for the system. For a subsea application of the system, this may be the benefit enabling CO₂ separation subsea. Alternative for the absorption cycle process the solvent regeneration column may be located on a topside installation.

FIG. 7 illustrates another alternative for the first or second additional treatment system. The gas stream to be treated 17/17′/25 is optionally compressed by compressor C-3 and optionally pre-treated in a pre-treatment unit 80 before being fed as stream 81 to a first membrane unit 82. The pre-treatment could comprise the removal of any substances with a harmful effect on the membrane or the function thereof. Within the first membrane unit 82 primarily CO₂ passes the membrane and the remaining gas 19/15 will comprise a limited amount of CO₂. The use and configuration of membrane separators is well known in the art. The sweetened gas 19/15 is processed further as discussed in connection with the FIGS. 2 to 5. Depending on the efficiency and selectivity of the membrane in the first membrane unit 82 the CO₂ rich gas 89 may be compressed in compressor C-4 and either passed directly to the further processing as stream 23/21, or alternatively the gas 89 may be fed to a second membrane unit 84 to obtain a CO₂ rich stream 87 which leaves the system as stream 23/21 and a hydrocarbon gas stream 85 which is returned to the stream 81 upstream the first membrane unit 82. The stream 23/21 is handled as discussed in relation to the FIGS. 2 to 5.

The shown membrane process shows optional compression and pre-treatment of the gas prior to the first membrane unit. Also optionally a compressor and potentially cooling can be applied on the CO₂ rich permeate 89. The CO₂ stream may be discharged directly or run through a secondary membrane unit to purify the CO₂ stream even more. Combinations of membrane units in parallel and/or series or cascade can be configured, all dependent on the requirements to achieve. Additional pre-treatment between membrane units and compression and cooling can be applied.

In this case no liquid hydrocarbon stream is discharged and no solvent is needed, hence streams 41/45 in FIGS. 3 to 5 and 61/63 in FIG. 5 are obsolete.

Benefits gained from a hybrid solution where the supersonic separator 6 removes the bulk of CO₂ and a first additional treatment system 8 according to FIG. 7 compared with a pure membrane process system are:
Reduced volume flow through the membrane unit giving potentially reduced membrane area required and number of stages required
Overall pressure drop may be reduced giving potential for less compression power required.

The purpose of the optional second additional treatment system 10 of the CO₂ rich reject stream 17/17′ is to recover more of the hydrocarbon gas and enrich the stream with respect to CO₂, if required.

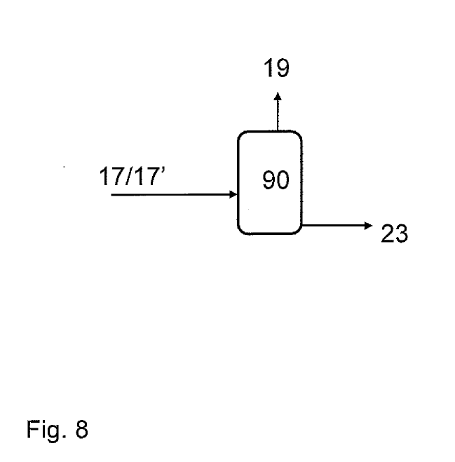

One solution can be to perform flashing of the liquid to flashing off light hydrocarbons (mainly methane) and without flashing off too much CO₂. This will further reduce the pressure, but maintain the CO₂ in the liquid phase. This process is illustrated in FIG. 8. The CO₂ rich stream 17/17′ from the second supersonic separator is fed to a flashing unit 90 at low temperature resulting in a hydrocarbon gas stream 19 to be processed further as discussed in connection with the FIGS. 2 to 5 and a liquid CO₂ stream 23 to be handled as discussed in connection with FIGS. 2 to 5. However the boosting unit 40 could be a pump as CO₂ is in a liquid state.

Another embodiment is to employ an absorption cycle process as shown in FIG. 6 as system 10.

Compared with a pure absorption solvent process, if the supersonic unit 6 can give the gas specification of the main gas stream without the need for the first additional treatment system 8, the benefits of this hybrid solution combining the supersonic separation 6 with the absorption solvent process as system 10 may be:
Reduced volume of solvent required
Reduced size of contactor and regeneration columns
Reduced size of additional equipment such as pumps, heat exchangers, coolers etc.
Reduced duty of reboiler in regeneration column
Reduced volume flow of solvent make-up stream

These benefits should reduce the overall size and utility requirement for the system. For a subsea application of the system, this may be the benefit enabling CO₂ separation subsea.

A third embodiment is to implement membrane separation process as shown in FIG. 7 as system 10.

Compared with a pure membrane process, if the supersonic unit 6 can give the gas specification of the main gas stream without the need for the first additional system 8, the benefits of this hybrid solution combining the supersonic separation 6 with the membrane process of FIG. 7 will be:
Highly reduced volume flow through the membrane unit (membranes not in the main feed stream) giving highly reduced membrane area required
Reduced size and complexity of the system
Potential for better membrane design focusing on selectivity between C2 hydrocarbon and CO₂ since C1 is generally associated with the main gas flow 13. This can further reduce the size of the membrane unit.
Reduce pressure drop through the membrane unit and potentially reduce the overall pressure drop, thereby reducing compression power required

In another solution for purifying stream 17′ in FIG. 5 could be to run the vaporized liquid through an additional supersonic separation unit. In this embodiment the second additional treatment system 10 is another supersonic treatment unit.

Overall system and component design will be dependent on the conditions and composition of the inlet stream 1 and the requirements to the discharge gas streams 43 and 51, and potentially the liquid stream 7′.

The process may be implemented in a topside or subsea environment.

The export gas leaving the system stream 51 will be low on CO₂ and also dehydrated to quite a low dew point, hence it should be fit for long distance transport.

Process simulations modelling the supersonic separation unit in Hysys indicate that thermodynamically CO₂ will be condensed as liquid within the unit and low concentrations can be achieved in the gas, however dependent on the gas composition and the process conditions.

Further it is considered that the current invention can be applied on-shore, off-shore topside and subsea.

1. A crude natural gas stream treatment system comprising:
a first supersonic separator which comprises a crude gas inlet, a dry gas outlet and a first liquid outlet;
a second supersonic separator which comprises a dry gas inlet, a treated gas outlet and a second liquid outlet;
wherein the dry gas outlet is in fluid communication with the dry gas inlet; and
a first heat exchanger which comprises a cooling medium inlet in fluid communication with the treated gas outlet, a cooling medium outlet in fluid communication with a treated gas inlet, an inlet for a medium to be cooled, said inlet being in fluid communication with the dry gas outlet, and a cooled fluid outlet in fluid communication with the dry gas inlet.

2. A crude natural gas stream treatment system comprising:
a first supersonic separator which comprises a crude gas inlet, a dry gas outlet and a first liquid outlet; and
a second supersonic separator which comprises a dry gas inlet, a treated gas outlet and a second liquid outlet;
wherein the dry gas outlet is in fluid communication with the dry gas inlet; and
wherein during operation of the system a treated gas from the treated gas outlet is heat exchanged with a dry gas from the dry gas outlet after dehydration in the first supersonic separator.

3. A crude natural gas stream treatment system comprising:
a first supersonic separator which comprises a crude gas inlet, a dry gas outlet and a first liquid outlet; and
a second supersonic separator which comprises a dry gas inlet, a treated gas outlet and a second liquid outlet;
wherein the dry gas outlet is in fluid communication with the dry gas inlet; and
wherein during operation of the system a dry gas from the dry gas outlet is cooled in a heat exchanger before entering the second supersonic separator.

4. The system according to claim 1, 2 or 3, further comprising a first additional treatment system which includes at least a treated gas inlet, a sweet gas outlet and a CO₂ gas outlet, wherein the treated gas outlet is in fluid communication with the treated gas inlet.

5. The system according to claim 4, wherein the first additional treatment system is an absorption separation system.

6. The system according to claim 4, wherein the first additional treatment system is a membrane separation system.

7. The system according to claim 2 or 3, further comprising a first heat exchanger which includes a cooling medium inlet in fluid communication with the treated gas outlet, a cooling medium outlet in fluid communication with the treated gas inlet, an inlet for a medium to be cooled, said inlet being in fluid communication with the dry gas outlet, and a cooled fluid outlet in fluid communication with the dry gas inlet.

8. The system according to claim 4, further comprising a second additional treatment system which includes at least a fluid inlet, a CO₂ outlet and a hydrocarbon outlet, wherein the second liquid outlet is in fluid communication with the fluid inlet and the hydrocarbon outlet is in fluid communication with one of the treated gas outlet or the sweet gas outlet.

9. The system according to claim 8, wherein the second additional treatment system is an absorption solution cycle system.

10. The system according to claim 8, wherein the second additional treatment system is a membrane separation system.

11. The system according to claim 8, wherein the second additional treatment system is flash separation system.

12. The system according to claim 8, wherein the second additional treatment system is a third supersonic separator.

13. (canceled)

14. The system according to claim 1, 2 or 3, wherein the first liquid outlet is in fluid communication with a well stream upstream of an initial phase separator which comprises a crude gas outlet in fluid communication with the crude gas inlet.

15. The system according to claim 1, 2 or 3 the system is configured for subsea installation.

16. A crude natural gas treatment method comprising:
passing crude natural gas through a first supersonic separator and a second supersonic separate;
wherein in the first supersonic separator the crude natural gas is cooled and a first condensed liquid stream is separated off to thereby provide a dry gas stream; and
wherein in the second supersonic separator the dry gas is cooled and a second condensed liquid stream is separated off to thereby provide a treated gas stream;
wherein said second condensed liquid stream comprises mainly CO₂ and C2 to C4 hydrocarbons.

17. (canceled)

18. The method according to claim 16, further comprising feeding the treated gas to a first additional treatment system.

19. The method according to claim 18, wherein the step of feeding the treated gas to a first additional treatment system comprises bringing the treated gas in contact with a CO₂ absorption solution, absorbing CO₂ in the solution to thereby obtain a sweetened gas stream, and regaining the solution by desorption of the absorbed CO₂.

20. The method according to claim 18, wherein the step of feeding the treated gas to a first additional treatment system comprises bringing the treated gas in contact with a CO₂ selective membrane and letting CO₂ pass through the membrane to obtain a sweetened gas stream.

21. The method according to claim 19 or 20, further comprising heating the treated gas upstream of the first additional treatment system by heat exchange with the dry gas.

22. The method according to claim 18, further comprising feeding the second liquid to a second additional treatment system.

23. The method according to claim 22, further comprising heating the second liquid through heat exchange with the dry gas upstream of the second supersonic separator to thereby obtain a second fluid.

24. The method according to claim 22, wherein the step of feeding the second liquid to a second additional treatment system comprises bringing the second liquid in contact with a CO₂ absorption solution, absorbing CO₂ in the solution to thereby obtain a hydrocarbon gas stream, and regaining the absorption solution by desorption of the absorbed CO₂.

25. The method according to claim 22, wherein the step of feeding the second liquid to a second additional treatment system comprises bringing the second liquid in contact with a CO₂ selective membrane and letting CO₂ pass through the membrane to obtain a hydrocarbon gas stream.

26. The method according to claim 22, wherein the step of feeding the second liquid to a second additional treatment system comprises flashing of hydrocarbons from the second liquid to obtain liquid CO₂.

27. The method according to claim 22, wherein the step of feeding the second liquid to a second additional treatments stem comprises passing the second liquid through a third supersonic separator, condensing and separating off liquid CO₂, and thereby obtaining hydrocarbon gas.

28. The method according to claim 16, further comprising feeding the first liquid to a well stream upstream of a phase separator, wherein the crude natural gas stream is obtained from said phase separator.

29. The method according to claim 16, wherein the method is performed subsea.
